(19) United States
(12) Patent Application Publication
(10) Pub. No.: US 2014/0173655 A1
(43) Pub. Date: Jun. 19, 2014

(54) ADVERTISEMENT SERVER, ADVERTISEMENT BROADCASTING TERMINAL, AND ADVERTISEMENT PUBLISHING METHOD

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: XIAO-GUANG LI, Shenzhen (CN); KUAN-HONG HSIEH, New Taipei (TW); JUN-FENG CHEN, Shenzhen (CN)

(73) Assignees: HON HAI PRECISION INDUSTRY CO., LTD., New Taipei (CN); HONG FU JIN PRECISION INDUSTRY (ShenZhen) CO., LTD., Shenzhen (CN)

(21) Appl. No.: 14/097,252

(22) Filed: Dec. 5, 2013

(30) Foreign Application Priority Data
Dec. 17, 2012 (CN) 201210547465X

(51) Int. Cl. H04N 21/81; H04N 21/2668

(52) U.S. Cl. CPC H04N 21/812; H04N 21/2668
USPC 725/34; 725/32

(57) ABSTRACT

An advertisement publishing method comprises following steps: recognizing current condition of the advertisement broadcasting terminal. Determining whether the recognized condition meets the publishing condition. Generating and sending a signal to the advertisement server to signal the advertisement server to provide an advertisement when the current condition of the advertisement broadcasting terminal meets the publishing condition. Generating an advertisement broadcasting interface and displaying the advertisement broadcasting interface on the display screen of the advertisement broadcasting terminal. And receiving the advertisement and broadcasting the advertisements provided by the advertisement server on the generated interface.

### BACKGROUND

1. Technical Field

The present disclosure relates to an advertisement server, an advertisement broadcasting terminal, an advertisement publishing system and an advertisement publishing method.

2. Description of Related Art

Display terminals, such as televisions, display a logo picture on the display screen during the process of starting the system or shutting down the system, which becomes boring.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of an advertisement publishing system, in accordance to an exemplary embodiment of the present disclosure.

FIG. 2 is block diagram of the advertisement publishing system in FIG. 1.

FIG. 3 is a flowchart of an advertisement broadcasting method, in accordance to an exemplary embodiment of the present disclosure.

FIG. 4 is a flowchart of an advertisement publishing method, in accordance to an exemplary embodiment of the present disclosure.

### DETAILED DESCRIPTION

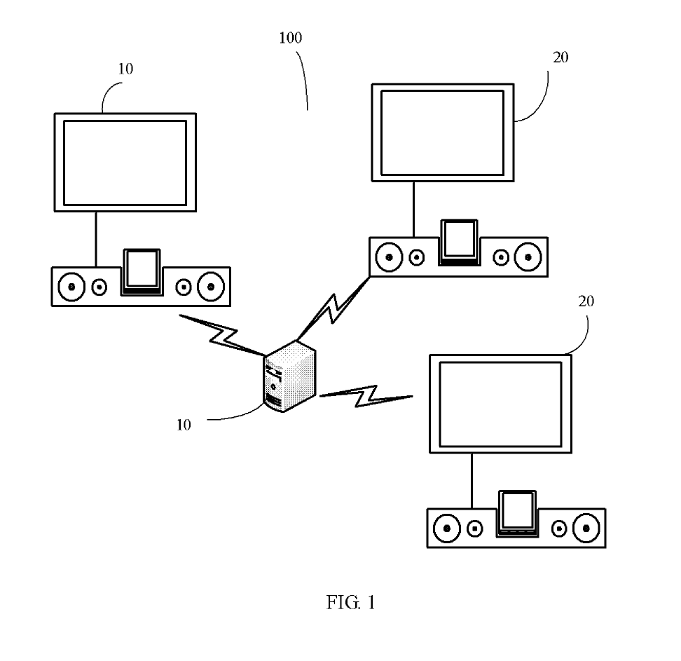

FIG. 1 shows an advertisement publishing system 100 in accordance to an exemplary embodiment. The advertisement publishing system 100 includes an advertisement server 10 and a plurality of advertisement broadcasting terminals 20. The advertisement server 10 communicates with the advertisement broadcasting terminals 20 to provide advertisements to the advertisement broadcasting terminals 20. In the embodiment, the advertisement broadcasting terminal 20 is a smart device, such as a smart TV, a mobile phone, a tablet computer or a personal computer. A user of each advertisement broadcasting terminal 20 is authorized by the advertisement publishing system 100, thus, the user is allowed to view the published advertisements via the system 100.

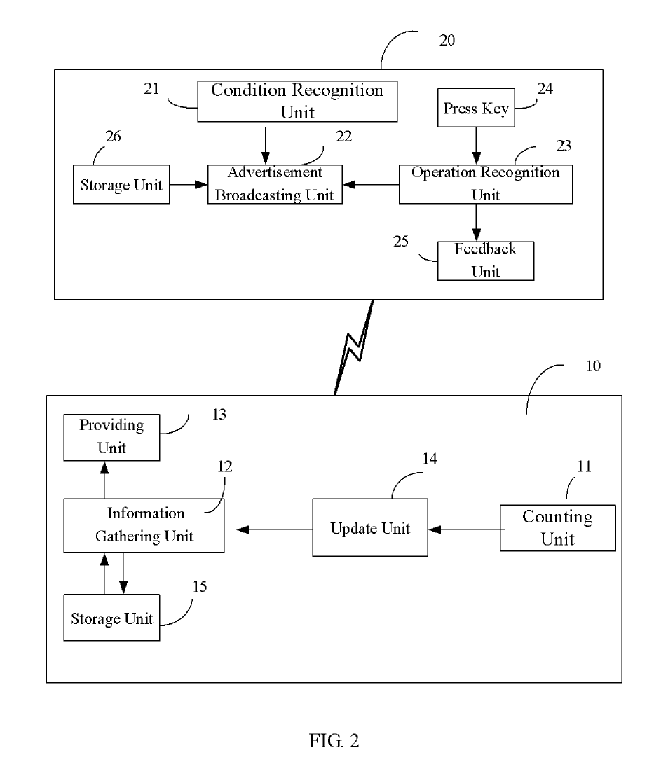

FIG. 2 shows that each of the advertisement broadcasting terminals 20 includes a condition recognition unit 21, an advertisement broadcasting unit 22, a operation recognition unit 23 and a feedback unit 25.

The condition recognition unit 21 is configured to recognize the current condition of the advertisement broadcasting terminal 20 and further determine whether the advertisement broadcasting terminal 20 is capable of publishing advertisements at the current condition, the condition for publishing advertisements is referred as “publishing condition”. In the embodiment, the “publishing condition” relates to time periods. When the advertisement broadcasting terminal 20 is either in a buffer period of switching channels, or in a time period of starting up or shutting down the advertisement broadcasting terminal 20, the condition recognition unit 21 determines the advertisement broadcasting terminal 20 meets the publishing condition and sends a signal to the advertisement server 10. The advertisement server 10 provides advertisements to the advertisement broadcasting terminal 20 according to a predetermined mode in response to the signal.

The advertisement broadcasting unit 22 is configured to generate an advertisement broadcasting interface and display the broadcasting interface on the display screen of the advertisement broadcasting terminal 20, and further broadcast the advertisements provided from the advertisement server 10 on the broadcasting interface.

In the embodiment, the display mode of the broadcasting interface is an angle mode, or a bubble mode, for example. In the angle mode the broadcasting interface is displayed on at least one of four angles of the display screen without covering the whole display screen. In the bubble mode the broadcasting interface is displayed on the display screen similar to a bubble floating on the display screen without covering the whole display screen. In other embodiments, the advertisement broadcasting unit 22 generates a transparent broadcasting interface overlaid on the display screen, thus not hiding other display content of the advertisement broadcasting terminal 20. In the embodiment, the advertisement broadcasting terminal 20 includes particular keys 24. The particular keys 24 are used to enlarge or reduce the size of the broadcasting interface, retrieve detailed information of items on the broadcasting interface, hide or close the broadcasting interface in response to operations on the particular keys 24. The advertisement broadcasted by the broadcasting terminal 20 may be a text advertisement, a picture advertisement, a video advertisement or a cartoon advertisement, for example.

The operation recognition unit 23 is configured to recognize a manual operation to the broadcasting interface. The advertisement broadcasting unit 22 controls the broadcasting interface to change in response to the recognized operation.

The feedback unit 25 is configured to transmit the operations recognized by the operation recognition unit 23 to the advertisement server 10 by the internet. The advertisement broadcasting terminal 20 further includes a storage unit 26 to store advertisements provided by the advertisement server 10.

The advertisement server 10 includes an information gathering unit 12, a providing unit 13, an update unit 14 and a storage unit 15.

The information gathering unit 12 is configured to gather information of users of the advertisement broadcasting terminals 20. The information gathering unit 12 further sends the gathered information to the storage unit 15 to be stored in the storage unit 15. The gather information includes user's preferences, which are provided by the advertisement providers. The advertisement providers gather user's preferences based on user's historical view data. The providing unit 13 is configured to provide an advertisement to the advertisement broadcasting terminal 20 when the advertisement broadcasting terminal 20 is in the publishing condition.

In another embodiment, the providing unit 13 is configured to communicate with the information gathering unit 12 and provide a matched advertisement which matches preferences of the user of the advertisement broadcasting terminal 20. For example, when the user of the advertisement broadcasting terminal 20 is a man who likes sports, this preference of this man is found because this man usually watches sports channels or browses the internet sports webpages, the advertisement providing unit 13 provides some advertisements about sporting goods or sports that meets the preferences of user.

The updating unit 14 is configured to update the user information stored in the storage unit 15 according to a manual operation associated with an advertisement.

The advertisement server 10 further includes a counting unit 11 to count the acceptance degree of an advertisement. When the advertisement server 10 provides an advertisement to a plurality of advertisement broadcasting terminals 20 according to both the content of the advertisement and the user information of the advertisement broadcasting terminals 20. The counting unit 11 counts the manual operations to the advertisement broadcasting interfaces feedback by the feedback units 15 of the advertisement broadcasting terminals 20, and gets the acceptance degree of the advertisement based on the manual operations associated with this advertisement. In the embodiment, if a user reduces the size of the advertisement broadcasting interface, hides or closes the advertisement broadcasting interface, the counting unit 11 counts that the user does not accept this advertisement. When the user enlarges the size of the advertisement broadcasting interface or just does not operate the advertisement broadcasting interface, the counting unit 11 counts that the user accepts the provided advertisement. The advertisement server 10 further sends the acceptance degree of an advertisement counted by the counting unit 11 to the advertisement provider.

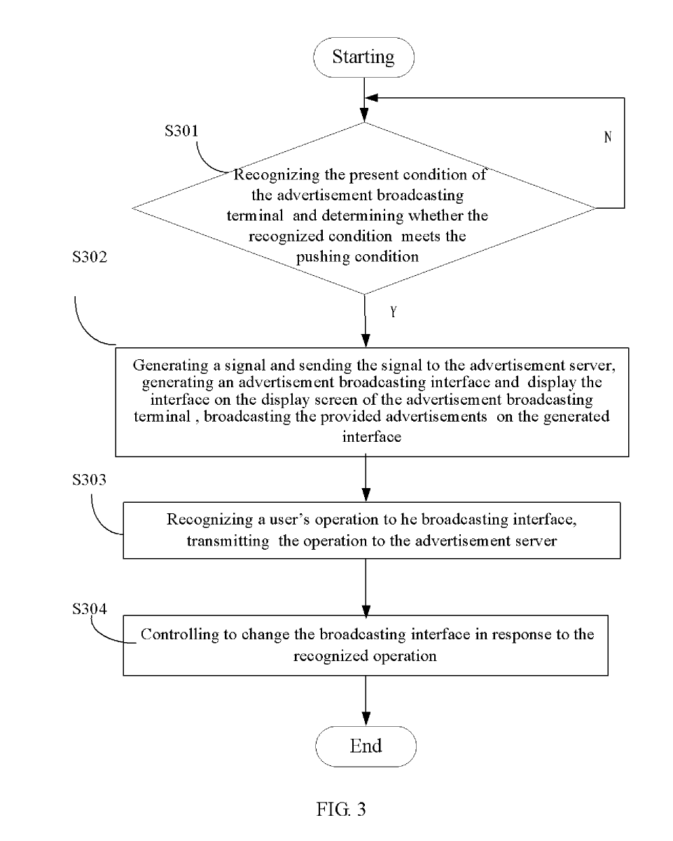

FIG. 3 shows a flowchart of an advertisement publishing method applied to the advertisement broadcasting terminal 20 for use in the advertisement publishing system 100. The method includes following steps:

In step S301, the condition recognition unit 21 recognizes the current condition of the advertisement broadcasting terminal 20 and determines whether the recognized condition meets the publishing condition, if yes, the process goes to step S302.

In the embodiment, when the advertisement broadcasting terminal 20 is either in a buffer period of switching channels, or in a time period of starting up or shutting down the advertisement broadcasting terminal 20, the condition recognition unit 21 determines the advertisement broadcasting terminal 20 meets the publishing condition.

In step S302, the condition recognized unit 21 generates a signal and sends the signal to the providing unit 13, the advertisement broadcasting unit 22 generates an advertisement broadcasting interface and display the interface on the display screen of the advertisement broadcasting terminal 20, and further broadcasts the advertisements provided by the providing unit 13 on the generated interface.

In step S303, the operation recognition unit 23 recognizes a manual operation to the broadcasting interface. In other embodiment, the feedback unit 25 is configured to transmit the operation recognized by the operation recognition unit 23 to the advertisement server 10 by the internet.

In the embodiment, the manual operation to the broadcasting interface may be enlarging or reducing the size of the broadcasting interface, retrieving detailed information of items on the broadcasting interface, hiding or closing the broadcasting interface.

In step S304, the advertisement broadcasting unit 22 controls the change of the broadcasting interface in response to the recognized operation.

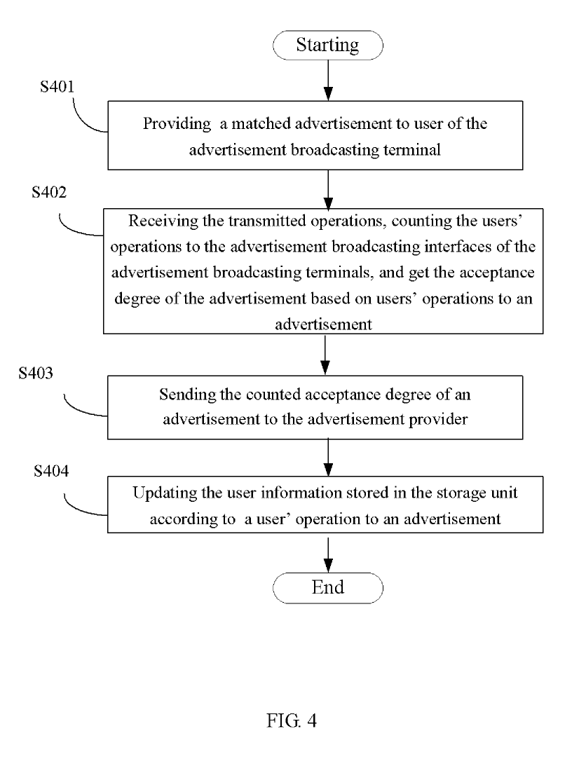

FIG. 4 shows a flowchart of an advertisement publishing method applied to the advertisement server 10 of the advertisement publishing system 100. The method includes following steps:

In step S401, the publishing unit 30 communicates with the information gathering unit 12 and provides a matched advertisement which matches the user's preferences to the user of the advertisement broadcasting terminal 20 according to the user's preferences gathered according to user's historical viewing data.

In step S402, the counting unit 11 receives the operations transmitted by the feedback 25, counts the manual operations to the advertisement broadcasting interfaces of the advertisement broadcasting terminals 20, and determines the acceptance degree of the advertisement based on manual operations to an advertisement.

In step S403, the advertisement server 10 sends the acceptance degree of an advertisement counted by the counting unit 11 to the advertisement provider.

In step S404, the updating unit 14 updates the user information stored in the storage unit 15 according to a manual operation associated with an advertisement.

Although the current disclosure has been described in considerable detail with reference to certain preferred embodiments thereof, the disclosure is not for limiting the scope of the disclosure. Persons having ordinary skill in the art may make various modifications and changes without departing from the scope and spirit of the disclosure. Therefore, the scope of the appended claims should not be limited to the description of the preferred embodiments described above.

What is claimed is:

1. An advertisement broadcasting terminal for use in an advertisement publishing system, the system comprising an advertisement server for providing advertisements to the advertisement broadcasting terminal, the advertisement broadcasting terminal comprising:
a display screen;
a condition recognition unit configured to recognize current condition of the advertisement broadcasting terminal and determine whether the recognized condition meets predetermined publishing condition;
an advertisement broadcasting unit configured to generate an advertisement broadcasting interface and display the broadcasting interface on the display screen, and further broadcast the advertisements provided by the advertisement server on the broadcasting interface.

2. The advertisement broadcasting terminal as described in claim 1, wherein the publishing condition is that the advertisement broadcasting terminal is either in a buffer period of switching channels, or in a time period of starting up or shutting down the advertisement broadcasting terminal.

3. The advertisement broadcasting terminal as described in claim 1, wherein the advertisement broadcasting terminal further comprises an operation recognition unit configured to recognize a manual operation to the broadcasting interface, and a feedback unit configured to transmit the recognized operations to the advertisement server.

4. The advertisement broadcasting terminal as described in claim 3, wherein the advertisement broadcasting unit is further configured to control the broadcasting interface to change in response to the recognized manual operations.

5. The advertisement broadcasting terminal as described in claim 4, wherein the manual operation is selected from the group consisted of enlarging the size of the broadcasting interface, reducing the size of the broadcasting interface, hiding the broadcasting interface, closing the broadcasting interface and retrieving detailed information of items on the broadcasting interface.

6. An advertisement server for use in an advertisement publishing system, the system comprising a plurality of advertisement broadcasting terminals communicating with the advertisement server to broadcast advertisements provided by the advertisement server, the advertisement server comprising:
a publishing unit configured to provide advertisements to one or more advertisement broadcasting terminals of which the users' preferences match with advertisements provided by the publishing unit when the one or more advertisement broadcasting terminals meet predetermined publishing conditions.

7. The advertisement server as described in claim 6, wherein the advertisement server comprises an information gathering unit configured to gather preferences of the users of the advertisement broadcasting terminals.

8. The advertisement server as described in claim 7, further comprising a count unit configured to receive manual operations to the advertisement broadcasting interfaces of the advertisement broadcasting terminal, count the manual operations and determine an acceptance degree of an advertisement based on the manual operations to the advertisement broadcasting interfaces.

9. The advertisement server as described in claim 8, wherein the advertisement server comprises an updating unit configured to update a user's preferences based on the manual operation associated with the advertisement.

10. The advertisement server as described in claim 9, wherein the advertisement server comprises a storage unit configured to store users' preferences and the acceptance degree of an advertisement.

11. An advertisement publishing method applied to an advertisement publishing system, the advertisement publishing system comprising a plurality of advertisement broadcasting terminals and an advertisement server providing advertisements to the advertisement broadcasting terminals, wherein a user of each advertisement broadcasting terminal is authorized by the advertisement publishing system to view the provided advertisements, the method comprising:
recognizing current condition of the advertisement broadcasting terminal and determining whether the recognized condition meets the publishing condition;
generating and sending a signal to the advertisement server to signal the advertisement server to provide an advertisement when the current condition of the advertisement broadcasting terminal meets the publishing condition;
generating an advertisement broadcasting interface and displaying the advertisement broadcasting interface on a display screen of the advertisement broadcasting terminal; and
receiving the advertisement and broadcasting the advertisements provided by the advertisement server on the generated interface.

12. The advertisement publishing method as described in claim 11, further comprising:
recognizing a user's operation to the advertisement broadcasting interface;
changing the advertisement broadcasting interface in response to the recognized operation; and
providing the recognized operation to the advertisement server to count manual operations to an advertisement on advertisement broadcasting interfaces and determine a acceptance degree of the advertisement based on manual operations associated with the advertisement.

13. The advertisement publishing method as described in claim 11, wherein the publishing condition is that the advertisement broadcasting terminal is either in a buffer period of switching channels, or in a time period of starting up or shutting down the advertisement broadcasting terminal.
